(19) United States
(12) Patent Application Publication
(10) Pub. No.: US 2004/0240664 A1
(43) Pub. Date: Dec. 2, 2004

(54) Full-duplex speakerphone

(76) Inventor: Evan Lawrence Freed, Summit, NJ (US)

Correspondence Address: Glen Farbanish, Telcordia Technologies, Inc., One Telcordia Drive 5G116, Piscataway, NJ, 08854-4157, US

(21) Appl. No.: 10/795,754

(22) Filed: Mar. 8, 2004

Related U.S. Application Data
(60) Provisional application No. 60/453,048, filed on Mar. 7, 2003.

(51) Int. Cl. H04M 9/08

(52) U.S. Cl. 379/406.01

(57) ABSTRACT

Characteristics of an implementation of my full-duplex speakerphone system, comprising transmit and receive suppress units, and acoustic and line echo cancellers, are determined once during manufacturing. The determined characteristics include a “total suppression” the combination of which the suppress units and echo cancellers must continuously provide to maintain stability and a midpoint value relative to total suppression. During operation, the system compares near-end and far-end speech power to midpoint to determine which side is speaking. During far-end speech, the system dynamically determines if the acoustic echo canceller has diverged in performance and if so, resets the echo canceller. The system then determines acoustic echo canceller performance and adjusts the system accordingly, varying the receive suppress unit to apply no suppression on the receive path and varying the transmit suppress unit to apply some suppression value less than “total suppression” on the transmit path. The opposite occurs when the system determines the near-end is speaking.

### CROSS-REFERENCE TO RELATED APPLICATIONS

This application claims the benefit of U.S. Provisional Application No. 60/453,048, filed Mar. 7, 2003, the contents of which are incorporated herein by reference.

### FIELD OF THE INVENTION

My invention relates generally to full-duplex speakerphones. More particularly, my invention relates to methods and systems for continuously determining which side of a speakerphone is speaking and based on this determination, varying the suppression between transmit and receive paths while dynamically adjusting the performance of acoustic and line echo cancellers.

### DESCRIPTION OF THE BACKGROUND

FIG. 1 is a high-level functional diagram of a prior-art full-duplex speakerphone 100. The system comprises an audio interface 102 for interfacing with a user and includes a speaker and microphone (not shown). System 100 also comprises a line interface 104 for interfacing with a communications network, such as a telephony network. Communications occur through a transmit path 106, which is from the audio interface 102 to the line interface 104, and through a receive path 108, which is from the line interface to the audio interface. In this system, a line interface echo 112 occurs at the line interface 104 from trans-hybrid rejection, or sidetone, and an audio interface echo 110 occurs at the audio interface 102 from acoustic energy picked up by the microphone from the speaker. Un-cancelled, these echoes may reach up to 0 dB on the line side and up to +20 dB on the audio side. If the sum of the line echo and acoustic echo is greater than or equal to 0 dB, system 100 becomes unstable and encounters “howling.”

In order to understand how full-duplex speakerphones traditionally operate, it is useful to first understand how half-duplex speakerphones traditionally operate and in particular, how these systems account for the echoes. In half-duplex operation, there is typically no acoustic echo canceller, although there may be a line echo canceller. In general, a half-duplex speakerphone deals with the echoes by always muting one path of the speakerphone depending upon a speech activity detector that continuously determines which side is speaking. More specifically, a common half-duplex speakerphone technique is to insert a transmit suppress module 118 in the transmit path and a receive suppress module 120 in the receive path and to then attempt to determine which side of the speakerphone is speaking at any given time (i.e., whether there is near-end speech at the audio interface 102 from the microphone or far-end speech at the line interface 104 from the Central Office). Based on this determination, the suppression module on the side/path opposite from which the speech energy is detected is activated to remove the echo appearing on that path. For example, when speech energy is detected at the near-end audio interface 102, the receive suppress module 120 is set to remove any energy from the receive path 108 while the transmit suppress module 118 is set to remove no speech energy from the transmit path 106. Similarly, when speech energy is detected at the far-end line interface 112, the transmit suppress module 118 is set to remove any energy from the transmit path 106 while the receive suppress module 120 is set to remove no speech energy from the receive path 108. Based on this flip-flopping of the suppression modules, the system remains stable. However, because one path always has suppression present, any valid speech on this path that may be present is removed along with an echo that is present, thereby resulting in the half-duplex operation.

In order to move a half-duplex phone towards full-duplex operation, the acoustic echo canceller 114 and the line echo canceller 116 are used. Specifically, the full-duplex speakerphone continues to operate like the half-duplex speakerphone, determining which side is speaking at any given time and applying suppression correspondingly to the appropriate path. However, the echo cancellers now allow the amount of suppression applied to be reduced, thereby allowing any speech on the path to pass through, resulting in full-duplex operation.

For example, when near-end speech is present, the receive suppress module 120 is set to suppress line interface echo 112 on the receive path 108. As such, it also removes any valid speech. However, the line echo canceller 116 is also intended to remove the resulting line interface echo 112. As such, because the line echo canceller is removing echo, the amount of suppression the receive suppress module 120 is applying to the receive path can be reduced. By reducing the suppression, any far-end also present on the path can now pass, resulting in full-duplex operation. The system similarly operates when far-end speech is detected.

While the basic techniques of flip-flopping suppression between the transmit and receive paths based on which side is speaking and then reducing the suppression through the echo cancellers are well known, how these techniques are implemented and integrated vary. More specifically, prior systems implementing this basic technique for providing full-duplex operation often do not adequately determine which side of the speakerphone is speaking at any given time. As a result, these systems will occasional apply suppression to the wrong path, resulting in the clipping of the near-end and far-end speech.

The operation of the acoustic and line echo cancellers in prior systems has also been inadequate. In particular, the performance of acoustic and line echo cancellers will vary based on the current environment (i.e., room surroundings, current network characteristics). As indicated above, the operation of the full-duplex speakerphone is dependent on the efficient operation of the echo cancellers. The better these units perform to remove echo, the lesser the amount of suppression the suppression modules need to apply to any given path, thereby giving the full-duplex operation. As such, if the echo cancellers are not efficiently performing to remove echo, more suppression must be added to any given line, moving the operation of the speakerphone towards half-duplex operation. More specifically, prior systems have used adaptive echo cancellers to provide the echo cancellation but have failed to efficiently adjust the performance of the echo cancellers to match the current environment in which the phone is operating, again resulting in the clipping of the near-end and far-end speech. In particular, these systems often adapt the echo cancellers prior to operation in an environment that is not representative of the environment that occurs during operation. Other systems attempt to adapt the echo cancellers during operation but doing such requires an accurate determination of which side is speaking. As indicated above, prior systems often do not adequately determine which side is speaking and as such, the echo canceller will train on signals that are not part the excitation vector, thus promoting divergence.

### SUMMARY OF MY INVENTION

Accordingly, it is desirable to have methods and apparatus that overcome the disadvantages of prior art systems. Specifically, my invention is a full duplex speakerphone system that incorporates methods and systems that more accurately determine which side of the phone is speaking at any given time and as such, more accurately vary the suppression on the transmit and receive paths resulting in less clipping of far-end and near-end speech as compared to the prior art. In addition, my invention dynamically adjusts the performance of acoustic and line echo cancellers to match the current environment and incorporates these adjustments during the active operation of the system while the system varies suppression between the transmit and receive paths. As a result, my inventive system removes more echo as compared to prior art systems, thereby reducing the amount of suppression the transmit and receive suppression modules need to apply and resulting in improved full-duplex operation as compared to prior art systems. My speakerphone system comprises an acoustic echo canceller across the audio interface, a line echo canceller across the line interface, a transmit suppress unit for supplying suppression to the transmit path, a receive suppress unit for applying suppression to the receive path, and a plurality of power estimation units along the transmit and receive paths.

In accordance with my invention, systems implementing my full-duplex speakerphone system are first run through a diagnostic procedure during manufacturing and under controlled conditions in order to determine worse case echo path gain. This diagnostic procedure is run under worst case conditions and results in a set of performance characteristics that are subsequently used during the operation of the system. In particular, the diagnostic procedure results in the determination of a TOTAL-SUPPRESSION value, which is the total suppression required in the speakerphone system during operation in order to keep it stable, and in a MIDPOINT value that is used to determine which side of the speakerphone is speaking.

Specifically, during the diagnostic procedure, a frequency sweep is first run from the near-end and then from the far-end making power estimates at each frequency on the transmit path (i.e., near-end speech) and the receive path (i.e., far-end speech). During these tests, the acoustic and line echo cancellers and the transmit and receive suppress units are ignored. Of the incremental frequency tests run from the far-end, a determination of the largest ratio of near-end speech power to far-end speech power is determined. Similarly, of the incremental frequency tests run from the near-end, a determination of the smallest ratio of near-end speech power to far-end speech power is determined. From these two values, the TOTAL-SUPPRESSION value is determined, which is essentially the difference of the two values plus a safe margin. Scaling one of the two values by TOTAL-SUPPRESSION, MIDPOINT is then computed as the mid-point between the two values.

Importantly, the significance of TOTAL-SUPPRESSION is that the combination of the echo cancellers and suppress units must always supply this amount of suppression during operation of the system in order to keep it stable. More specifically, as the system operates and determines which side is speaking, it inversely varies in incremental steps the suppression between the transmit and receive suppress units, moving one side towards no suppression and the other side towards full suppression (i.e., TOTAL-SUPPRESSION). However, at the same time, the system monitors the performance of the echo cancellers to determine the amount of echo being removed and based on this determination, moves the one side migrating towards TOTAL-SUPPRESSION away from TOTAL-SUPPRESSION and thereby providing full-duplex operation. Nonetheless, between the suppress units and echo cancellers, the system always has TOTAL-SUPPRESSION applied. As for MIDPOINT, the system continuously compares power estimates of near-end and far-end speech to MIDPOINT during operation to determine which side is currently speaking (note that to account for the application of suppression between the suppress units and echo cancellers, MIDPOINT is scaled during this determination). This determination is important for two reasons. First, this determination indicates which of the two suppress units should be adding suppression to its corresponding path and which suppress unit should be removing suppression. In addition, as indicated above, my invention continuously monitors the performance of the echo cancellers during operation and resets an echo canceller if its performance has diverged. Importantly, in order to properly determine new echo canceller coefficients, the echo canceller must only be reset when the opposite end is speaking.

Once TOTAL-SUPPRESSION and MIDPOINT are determined, these values are configured into the system for operation. As just described, during operation, my speakerphone system continuously makes near-end and far-end speech power estimates and compares the ratio of these two estimates to MIDPOINT to make a determination of which side is speaking. Assuming the system determines the far-end is speaking, the system first uses the power estimation units within the transmit path to determine if the acoustic echo canceller has diverged in its performance. If divergence is detected, the system resets the echo canceller's filter coefficients and places the echo canceller in training mode such that the filter retrains to the current environment. Whether retrained or not, the system next determines the performance of the acoustic echo canceller and in particular, uses power estimation units to determine the amount of echo the echo canceller is removing from the system. Again, this is significant because without the echo canceller, the transmit suppress unit would need to eventually apply TOTAL-SUPPRESSION to the transmit path. However, the acoustic echo canceller performance moves the transmit suppress unit away from TOTAL-SUPPRESSION and in essence, provides a ceiling (i.e., a value that is less than TOTAL-SUPPRESSION) as to the amount of suppression the transmit suppress unit needs to supply. Note that the system may continuously detect improvements and degradation in the echo canceller's performance and as such, this “ceiling” will not necessarily remain stationary. Once having the echo canceller's performance, the system next moves the receive suppress unit towards no suppression and moves the transmit suppress unit towards adding suppression but at the same time tracks the ceiling as established by the acoustic echo canceller. The system proceeds similarly when it determines the near-end is speaking, monitoring the performance of the line echo canceller, removing suppression from the transmit suppress unit, and adding suppression to the receive suppress unit, again, accounting for the line echo canceller's performance.

Again, it is important to note that suppression is constantly inversely varied between the two suppress units and is varied in an incremental fashion. It is also important to note that this movement must be done such that the system always maintains a level of suppression at TOTAL-SUPPRESSION. As such, the system always varies the suppression between the two suppress units in a linear fashion.

### BRIEF DESCRIPTION OF THE DRAWINGS

FIG. 1 depicts a functional architecture of a prior art full-duplex speakerphone.

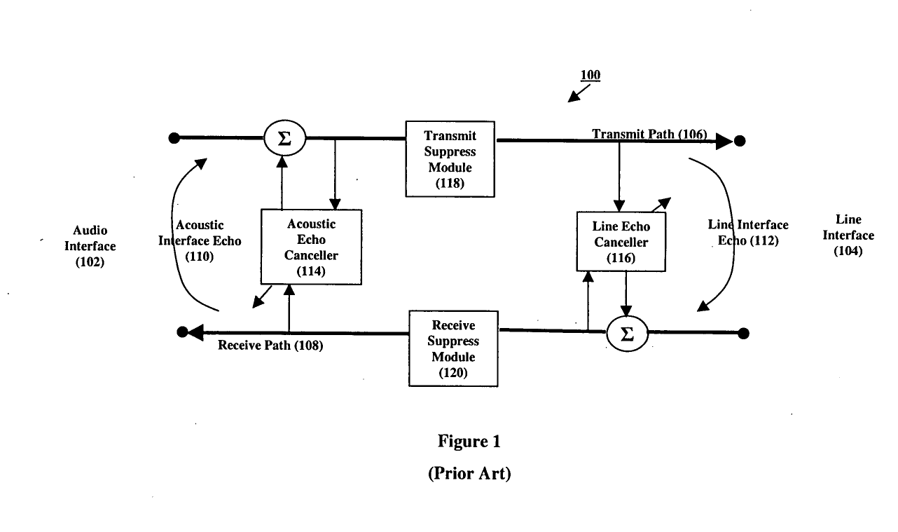

FIG. 2 depicts a functional architecture of one illustrative embodiment of my invention for a full-duplex speakerphone system.

FIG. 3 depicts high-level method steps of the functional execution of my full-duplex speakerphone system including determining which side of the speakerphone is speaking and based on this determination, dynamically adjusting the performance of the acoustic and line echo cancellers and also varying suppression between transmit and receive paths while accounting for the performance of the acoustic and line echo cancellers.

FIG. 4 depicts method steps of my invention for experimentally determining performance parameter values of any given implementation of my speakerphone, which values are subsequently used by the speakerphone to continuously determine which side of the speakerphone is speaking.

FIGS. 5A and 5B depict functional test configurations on which the methods steps of FIG. 4 are executed.

FIGS. 6A and 6B show exemplary test results resulting from the execution of the methods steps of FIG. 4.

FIG. 7 shows a graphical representation of the exemplary test results of FIGS. 6A and 6B and further shows a graphical representation of the performance parameter values determined from the method steps of FIG. 4.

FIG. 8A depicts a functional architecture of a prior art adaptive linear echo canceller.

FIG. 8B depicts a functional architecture of the adaptive linear echo canceller of FIG. 8A and includes a power estimation unit that is used in accordance with one embodiment of my invention during the dynamic adjustment of an echo canceller.

FIGS. 9A and 9B depict method steps of one illustrative embodiment of my invention, further detailing the method steps of FIG. 3.

### DETAILED DESCRIPTION OF MY INVENTION

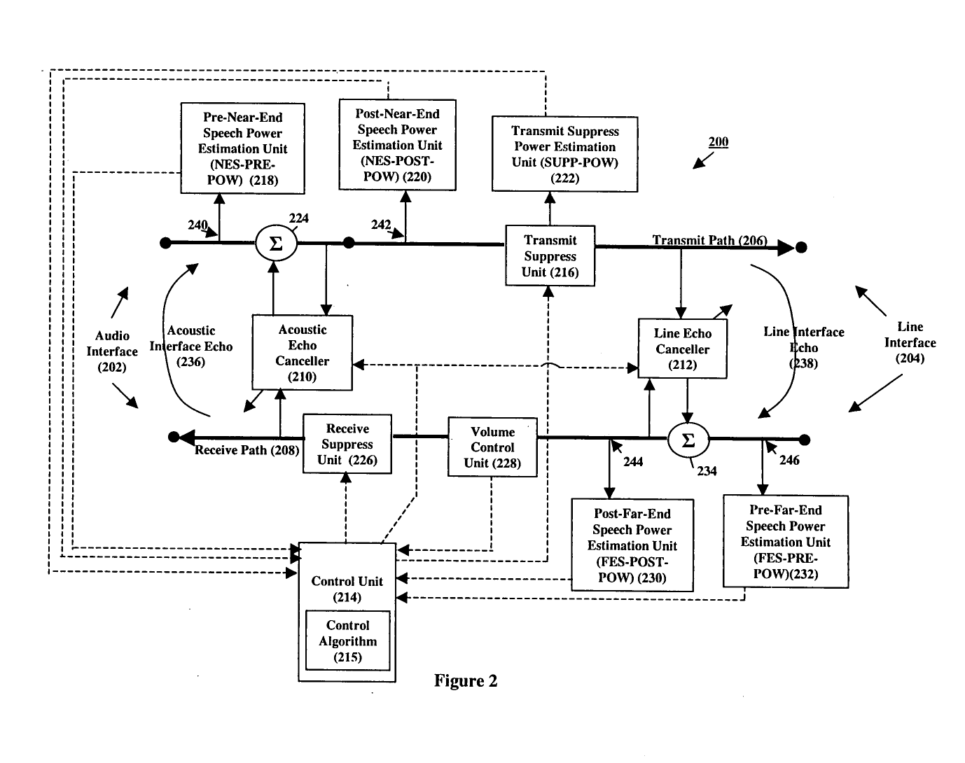

FIG. 2 is a functional diagram of my full-duplex speakerphone system 200. System 200 is a digital-based system comprising an audio interface 202, a line interface 204, a transmit path 206, a receive path 208, a transmit suppress unit 216, a receive suppress unit 226, an acoustic echo canceller 210, a line echo canceller 212, a control algorithm 215, a control unit 214 on which the control algorithm executes, and several power estimation units including a pre-near-end speech power estimation unit (hereinafter “NES-PRE-POW”) 218, a post-near-end speech power estimation unit (hereinafter “NES-POST-POW”) 220, a transmit suppress power estimation unit (hereinafter “SUPP-POW”) 222, a post-far-end speech power estimation unit (hereinafter “FES-POST-POW”) 230, and a pre-far-end speech power estimation unit (hereinafter “FES-PRE-POW”) 232. Audio interface 202 comprises analog-to-digital converters, a speaker, and a microphone, each of which are not shown in FIG. 2. Line interface 204 interfaces a communications network, such as an analog telephony network or a digital data network, and includes a data access arrangement (DAA) for interfacing the communications network and may also include analog-to-digital converters depending on the type of communications network (again, the DAA and analog-to-digital converters are not shown in FIG. 2).

From the perspective of a user, near-end speech is transmitted from the audio interface 202 towards the line interface 204 through transmit path 206 and far-end speech is received from the line interface towards the audio interface through the receive path 208. The transmit path 206 comprises the transmit suppress unit 216, which is a variable suppression unit that multiplies the near-end speech by some factor less than one in order to remove near-end speech energy on the transmit path. Similarly, the receive path 208 comprises the receive suppress unit 226, which again is a variable suppression unit that multiplies the far-end speech by some factor less than one in order to remove far-end speech energy on the receive path. As further described below, the control algorithm actively determines which side is speaking and based on this determination, varies suppression between the two suppress units 216 and 226 depending on which side is speaking. Specifically, when the near-end is speaking, the control algorithm increases suppression in the receive suppress unit and decrease suppression in the transmit suppress unit. Similarly, when the far-end is speaking, the control algorithm increases suppression in the transmit suppress unit and decreases suppression in the receive suppress unit.

In addition to the transmit suppress unit 216, the transmit path also comprises the three power estimation units NES-PRE-POW 218, NES-POST-POW 220, and SUPP-POW 222. NES-PRE-POW 218 and NES-POST-POW 220 determine power estimates of the near-end speech energy present at points 240 and 242 respectively on the transmit path. SUPP-POW 222 determines a power estimate of the suppression being applied by the transmit suppress unit 216. Similarly, the receive path comprises the two power estimation units FES-POST-POW 230 and FES-PRE-POW 232. FES-POST-POW 230 and FES-PRE-POW 232 determine power estimates of the far-end speech energy present at points 244 and 246 respectively on the receive path. Each of these power estimations units 218, 220, 222, 230, and 232 represents, for example, the following recursion, which is useful in estimating a signal power over a certain window of samples:

Power(i)=power(i−1)*b+x(i)*x(i)*a (1)

where “a” is “1/window-length”, “b” is “1−a”, and “x(i)” is the input signal.

Turning to the echo cancellers, the acoustic echo canceller 210 estimates the acoustic interface echo 236 and through module 224, removes this estimated echo from the transmit path 206 thereby attenuating the echo 236. Similarly, the line echo canceller 212 estimates the line interface echo 238 and through module 234, removes this estimated echo from the receive path 208 thereby attenuating the echo 238. Significantly, the acoustic interface echo 236 and the line interface echo 238 can be modeled as linear systems. As such, the acoustic echo canceller 210 and the line echo canceller 212 are also modeled as linear systems/filters. In general, the control algorithm operates the two echo cancellers in conjunction with the transmit and receive suppress units 216 and 226 to reduce the amount of suppression each suppress unit must apply to its corresponding communications path, thereby providing full-duplex operation.

Significantly and in accordance with my invention, both the acoustic echo canceller 210 and the line echo canceller 212 are adaptive filters and are continuously operated in one of two modes by the control algorithm, training mode and operational mode. Specifically, the conditions under which speakerphone 200 operates can change causing the echo cancellers to operate ineffectively and diverge from preset configurations. As such, the control algorithm continuously monitors the acoustic echo canceller 210 and the line echo canceller 212 during the normal operation of system 200 and resets the echo cancellers whenever a divergence is detected. Accordingly, the control algorithm continuously varies the echo cancellers between operational mode and training mode. During training mode, the echo cancellers process all input signals to determine a set of filter coefficients that best estimate the interface echo, as is further described below. During operational mode, these filter coefficients are held constant and the filters estimate their respective echoes and remove these echoes from the communications path via modules 224 and 234.

As a general notion and as further described below, each echo canceller should only be retrained while the opposite side is speaking. In other words, the acoustic echo canceller 210 should only be trained when the far-end is speaking and the line echo canceller 212 should only be trained when the near-end is speaking. If either echo canceller is retrained while its corresponding side is speaking, the filter coefficients will tend to diverge, worsening the echo canceller's performance. As such, in addition to determining which side is speaking in order to vary suppression between the suppress units, the control algorithm determines which side is speaking in order to determine which echo canceller can be retrained (if necessary).

Turning to the control unit 214, it is digital processor that interfaces with the power estimation units 218, 220, 222, 230, and 232, the transmit suppress unit 216, the receive suppress unit 226, and the acoustic and line echo cancellers 210 and 212. Control unit 214 also executes control algorithm 215.

Control algorithm 215 oversees the operation of system 200. In general, the algorithm continuously monitors the power estimates determined by the power estimation units. Based on these power estimates, the control algorithm makes a constant determination as to whether the near-end (i.e., acoustic interface 202) or far-end (i.e., line interface 204) is speaking. Based on this determination, the control algorithm inversely varies the transmit suppress unit 216 and the receive suppress unit 226 to increase and decrease the amount of suppression each applies to its respective path. Without the acoustic and line echo cancellers 210 and 212, the control algorithm would essentially maintain the speakerphone 200 in half-duplex operation as it varies the two suppress units. However, the control algorithm also uses the power estimation units to continuously determine the amount of echo the echo cancellers are removing from system 200. Based on this determination, the control algorithm decreases the amount of suppression the transmit suppress unit 216 and receive suppress unit 226 are applying (depending on which unit is currently applying suppression) and as such, moves system 200 away from half duplex operation towards full duplex operation. Furthermore, while performing the full-duplex operation, the control algorithm also uses the power estimation units to determine if the echo cancellers have diverged in performance. Based on the control algorithm's determination of which side is speaking and based on its determination of divergence in an echo canceller, the control algorithm will cause an echo canceller to automatically retrain itself based on the current conditions. By continuously having the echo cancellers match their performance to the current conditions, the control algorithm is able to improve the amount of echo each is removing and thereby improve the full-duplex operation of system 200.

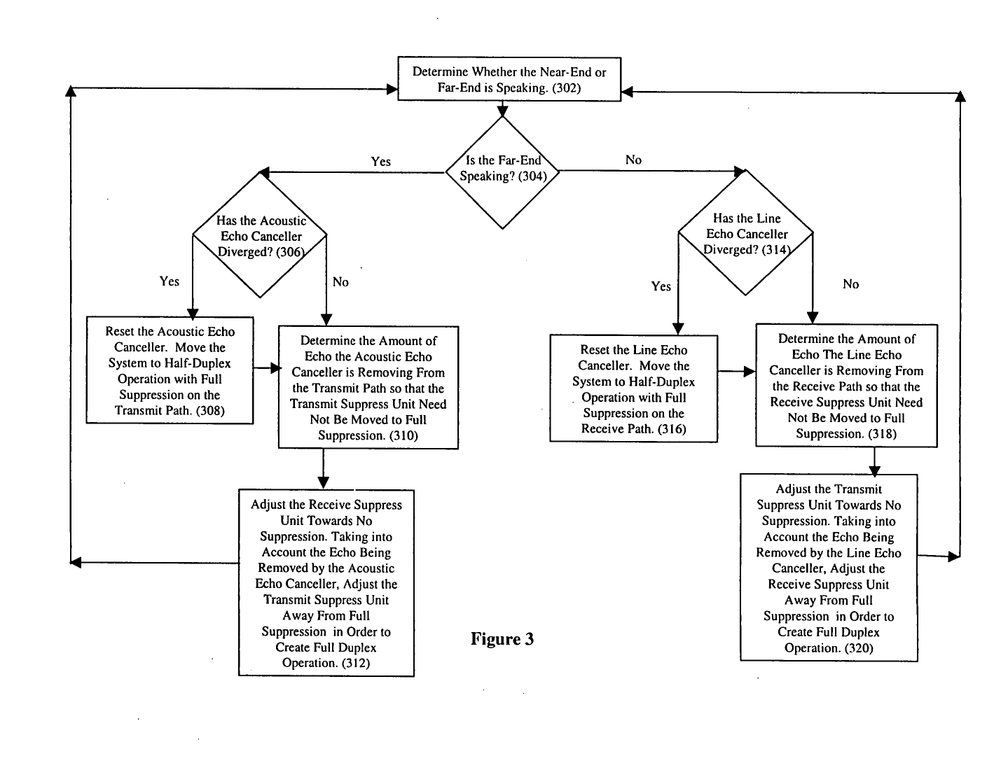

Based on the foregoing, FIG. 3 shows a high flow diagram of control algorithm 215 and the operation of speakerphone system 200. The control algorithm moves through this flow on each voice sample received, although it may move through this flow less frequently (i.e., as described below, the control algorithm through each pas of the algorithm is updating suppression values and then applying these values to the voice samples. While every voice sample must be properly attenuated, the control algorithm does not need to calculate new suppression values for each sample and may do so less frequently). Beginning with step 302, control algorithm 215 first uses NES-PRE-POW 218, FES-PRE-POW 232, and SUPP-POW 222 to determine-whether the near-end (i.e., acoustic interface 202) or far-end (i.e., line interface 204) is speaking. This determination is necessary because it indicates on which path (transmit path 206 or receive path 208) suppression should be increased and on which path suppression should be decreased. In addition, this determination indicates which echo canceller can be retrained. As such, the system proceeds in one of two directions based on this determination, as shown by step 304. Again, when the far-end is speaking, suppression needs to be added to the transmit suppress unit and removed from the receive suppress unit. In addition, the acoustic echo canceller can be retrained, if necessary. The opposite occurs when the near-end is speaking.

In particular, if the control algorithm determines the far-end is speaking, it monitors NES-PRE-POW 218 and NES-POST-POW 220 to determine if the acoustic echo canceller 210 has diverged (step 306). If divergence is detected, the control algorithm moves to step 308, clearing the acoustic echo canceller's filter coefficients to zero and putting the acoustic echo canceller in training mode to re-determine its filter coefficients. In addition, because the acoustic echo canceller has been reset, the control algorithm places the system back into half-duplex operation, configuring the transmit suppress unit 216 to add full suppression to the transmit path (i.e., uncompensating the transmit suppress unit from the effects of the echo canceller) and configuring the receive suppress unit 226 to remove suppression from the receive path. The control algorithm then proceeds to step 310 (alternatively, the algorithm could proceed back to step 302). If the control algorithm in step 306 determines the acoustic echo canceller 210 has not diverged, it bypasses step 308 and again moves to step 310.

In step 310 the control algorithm next monitors and adjusts the suppression being applied to the transmit and receive paths. In particular, because the far-end is speaking, the control algorithm needs to decrease the amount of suppression the receive suppress unit 226 is applying to the receive path 208 and increase the amount of suppression the transmit suppress unit 216 is applying to the transmit path 206. However, the control algorithm must also account for the performance of the acoustic echo canceller (i.e., the echo being removed). As such, the control algorithm first monitors in step 310 NES-PRE-POW 218 and NES-POST-POW 220 to determine the amount of echo the acoustic echo canceller 210 is removing from the transmit path. The control algorithm uses this determination to estimate an amount of suppression the transmit suppress unit 216 can be decreased by in order to move the system towards full-duplex operation. Finally, in step 312, the control algorithm adjusts the receive suppress unit 226 towards no suppression and adjusts the transmit suppress unit 216 towards full suppression but takes into account the echo being removed by the acoustic echo canceller, thereby keeping the system in full-duplex operation. The control algorithm then returns to step 302 to repeat the process. Importantly, note that the control algorithm does not starkly move the receive and transmit suppress units between no-suppression and full suppression but rather, makes the transition in a step wise fashion. In other words, during each pass through steps 306-312, the control algorithm will migrate the receive and transmit suppress units between no-suppression and full suppression, respectively, again taking the acoustic echo canceller performance into account. This process is further detailed below.

If the control algorithm determines in step 304 that the near-end is speaking rather than the far-end as described above, the control algorithm moves to step 314 where it monitors FES-PRE-POW 232 and FES-POST-POW 230 to determine if the line echo canceller 212 has diverged. If divergence is detected, the control algorithm moves to step 316, clearing the line echo canceller's filter coefficients to zero and putting the line echo canceller in training mode to re-determine its filter coefficients. In addition, the control algorithm places the system back into half-duplex operation, configuring the receive suppress unit 216 to add full suppression to the receive path and configuring the transmit suppress unit 226 to remove suppression from the transmit path. The control algorithm then proceeds to step 318 (alternatively, the algorithm could proceed back to step 302). If the control algorithm in step 314 determines the line echo canceller 212 has not diverged, it bypasses step 316 and again moves to step 318.

In step 318 the control algorithm next monitors and adjusts the suppression being applied to the transmit and receive paths. Specifically, because the near-end is now speaking, the control algorithm needs to decrease the amount of suppression the transmit suppress unit is applying to the transmit path 206 and to increase the amount of suppression the receive suppress unit is applying to the receive path 208. However, similar to above, the control algorithm must account for the echo the line echo canceller is removing from the receive path. Accordingly, the control algorithm first monitors FES-PRE-POW 232 and FES-POST-POW 230 to determine the amount of echo the line echo canceller 212 is removing from the receive path in order to estimate an amount of suppression the receive suppress unit 226 can be decreased by in order to move the system towards full-duplex operation. Once making this determination, the control algorithm moves to step 320 and adjusts the transmit suppress unit 216 towards no suppression and adjusts the receive suppress unit 226 towards full suppression, taking into account the echo being removed by the line echo canceller and thereby keeping the system in full-duplex operation. The control algorithm then returns to step 302 to repeat the process. Again, note that the control algorithm does not starkly move the transmit and receive suppress units between no-suppression and full suppression but rather, makes the transition in a stepwise fashion as described above.

Reference will now be made in greater detail to steps 302 and 304 of the control algorithm for determining at any give time which side of the speakerphone is speaking. Next, the operation of the acoustic and line echo cancellers will be more fully described. Finally, the remaining steps of 306-320 of the control algorithm 215 will be more fully described.

As indicated, the control algorithm needs to continuously determine whether the near-end or far-end is speaking in order to vary suppression within system 200 and in order to determine which echo canceller can be retrained. The control algorithm makes this determination as to which side is speaking by examining a ratio of power estimates taken on both near-end speech and far-end speech as shown in equation (2).

Ratio (i)=NES-PRE-POW(i)/FES-PRE-POW(i) (2)

NES-PRE-POW 218 and FES-PRE-POW 232 are in accordance with equation (1). More specifically, the control algorithm compares the ratio of equation (2) to a median value, which we refer to as MIDPOINT. When the ratio is greater than MIDPOINT, the control algorithm declares the near-end to be speaking and when the ratio is less than MIDPOINT, the control algorithm declares the far-end to be speaking. This determination is shown in equaion (3).

| | |
|---|---|
| If (NES-PRE-POW/FES-PRE-POW > MIDPOINT) | (3) |

→ the near-end is speaking.

else

→ the far-end is speaking.

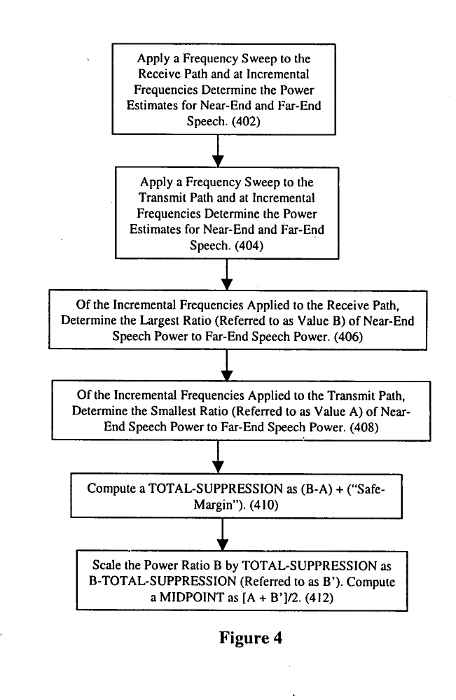

For any given speakerphone implementation utilizing my inventive system 200, MIDPOINT will vary depending on the telephone plastics/shape used in manufacturing the speakerphone casing, will vary based on the DAA used to connect the speakerphone to the communications network, and will vary based on the audio equipment (speakers and microphone) used. Accordingly, any given speakerphone utilizing my inventive system 200 will have a different MIDPOINT value. As such, during the manufacturing of a speakerphone using my inventive system 200, the phone must be tested to determine a MIDPOINT value and to determine a TOTAL-SUPPRESSION value, which is further described below. Note that the control unit 214 executes a diagnostic algorithm, as shown in FIG. 4, to determine these values. This diagnostic algorithm is only run once during manufacturing of the speakerphone. It is never run during the operation of the speakerphone. Once the values are determined, they are programmed into system 200 and used by control algorithm 215 to provide full-duplex operation. What follows is description of the diagnostic algorithm of FIG. 4 for determining MIDPOINT and TOTAL-SUPPRESSION. Following the description of this diagnostic algorithm, a more complete description of equation (3) is provided.

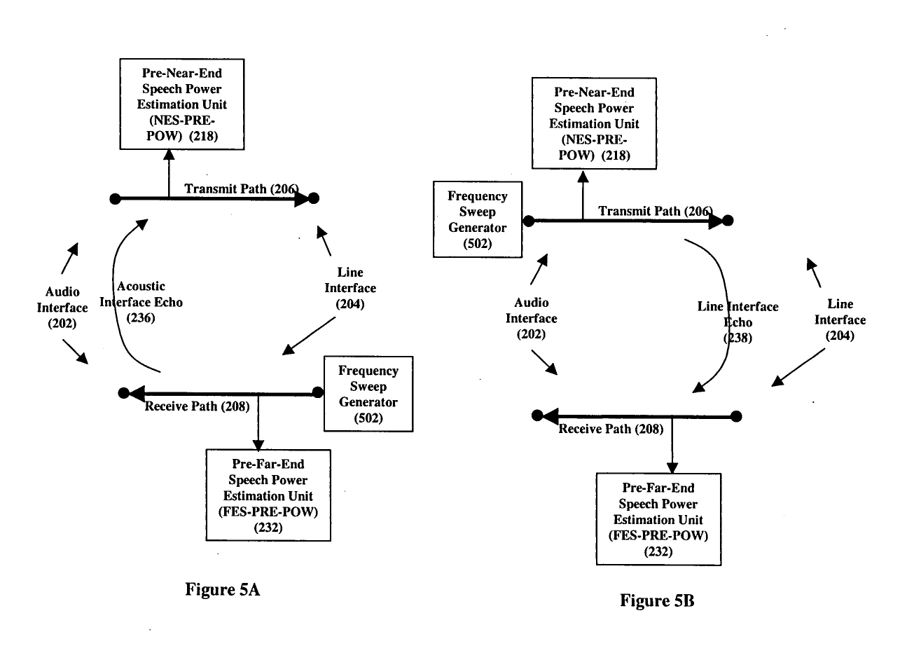

Beginning with step 402 and a shown by FIG. 5A, a frequency sweep generator 502 is first applied to the receive path 208 from the line interface 204. As shown by FIG. 5A, the acoustic and line echo cancellers 210 and 212 and the transmit and receive suppress units 216 and 226 are ignored during this test. The frequency sweep generator 502 transmits tones increasing in frequency by small steps from DC to 4 KHz. Note that the frequency sweep generator 502 can be an external system or preferably, is provided by the control unit 214. At each frequency, the diagnostic algorithm determines the power estimates for near-end and far-end speech using NES-PRE-POW 218 and FES-PRE-POW 232. During these tests, only the frequency sweep generator and the acoustic and line echoes are considered. In other words, the transmit and receive paths are assumed muted. Note that the sweep occurs slow enough relative to the window length of the power estimates so that transient effects of the recursion can be ignored.

In step 404 and as shown by FIG. 5B, frequency sweep generator 502 is next applied to the transmit path 206 from the audio interface 202 transmitting tones increasing in frequency by small steps from DC to 4 KHz. Again, the acoustic and line echo cancellers 210 and 212 and the transmit and receive suppress units 216 and 226 are ignored during this test and the transmit and receive paths are assumed muted. At each frequency, the diagnostic algorithm again determines the power estimates for near-end and far-end speech using NES-PRE-POW 218 and FES-PRE-POW 232.

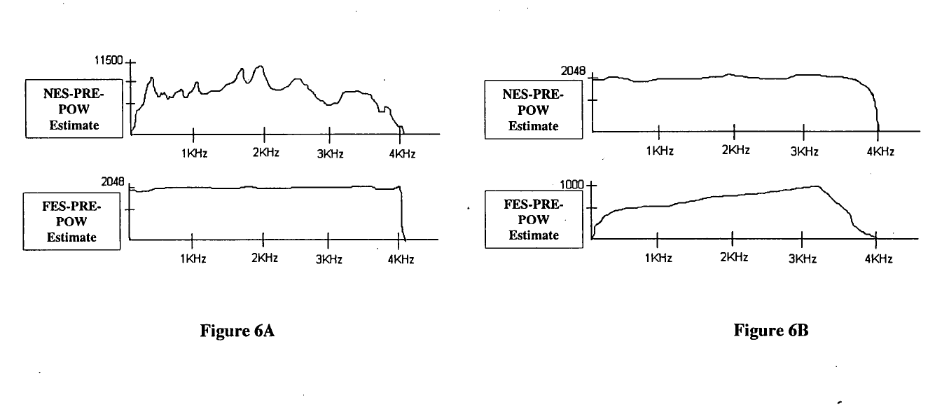

FIG. 6A shows exemplary power estimates when the frequency sweep generator 502 is applied to the far-end (as in FIG. 4A) and FIG. 6B shows exemplary power estimates when the frequency sweep generator is applied to the near-end (as in FIG. 4B) (note that the exemplary power estimates are 16 bit and thus have a range of 0 to 32768). As shown in exemplary FIG. 6A, when far-end speech is applied, the power ratio NES-PRE-POW/FES-PRE-POW ranges from about 5.6 (11,500/2048) at around 2 KHz and decreases for other frequencies down to around 1. Taking 20*log10 of these values, the NES-PRE-POW/FES-PRE-POW power ratio ranges from about 15 dB to 0 dB. Similarly, as shown by exemplary FIG. 6B, when near-end speech is applied, the power ratio NES-PRE-POW/FES-PRE-POW ranges from 2.0 (or 6 dB) at about 3.2 KHz to around 8.0 (18 dB). For the purposes of determining MIDPOINT, the diagnostic algorithm determines in step 406 the largest ratio when far-end speech is applied, which here is 5.6 or 15 dB (which we can refer to as value B). Similarly, the diagnostic algorithm determines in step 408 the smallest ratio when near-end speech is applied, which here is of 2.0 or 6db (which we can refer to as value A). For the purposes of the tests, these are considered the worst-case ratios.

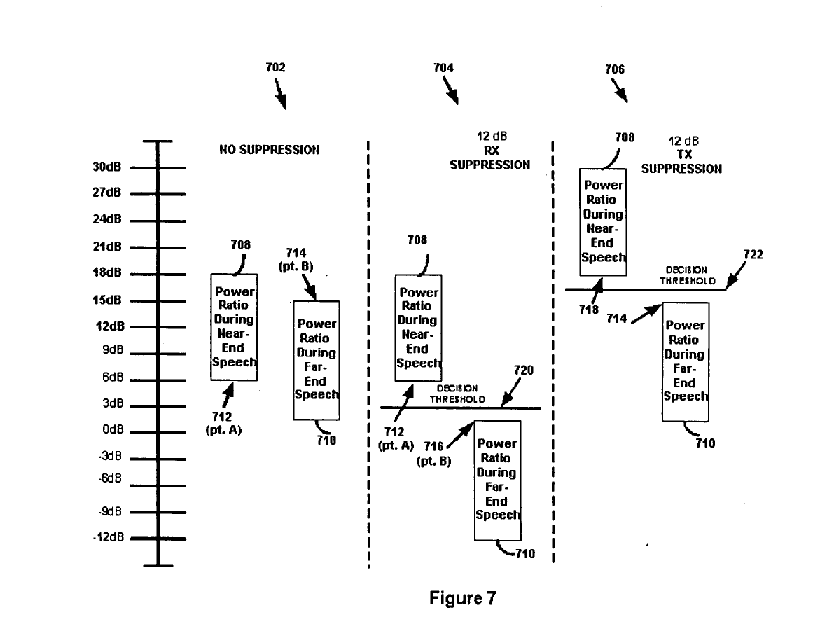

For illustration purposes, FIG. 7 column 702 (i.e., the column labeled “NO SUPPRESSION”) shows the NES-PRE-POW/FES-PRE-POW power ratios for the above exemplary tests. Specifically, bar 708 shows the minimum to maximum range of power estimates across the frequency sweep when the frequency sweep is applied as near-end speech (i.e., test scenario FIG. 5B). Point 712 indicates the worst case of 6 dB as discussed above. Similarly, bar 710 shows the minimum to maximum range of power estimates across the frequency sweep when the frequency sweep is applied as far-end speech (i.e., test scenario FIG. 5A). Point 714 indicates the worst-case of 15 dB as discussed above.

As the graph in column 702 shows, there is an overlap of bars 708 and 710 and as such, it will be impossible to determine whether the near-end or far-end is speaking at any given time. In addition, because the bars overlap, system 200 is not stable and will exhibit howling. Specifically, if point 712 is less than point 714, system 200 is not stable and suppression must be applied. In particular, sufficient suppression must be applied to separate bars 708 and 710. We refer to this amount of suppression as TOTAL-SUPPRESSION. Again, for illustration purposes, if we now add the transmit suppress unit 206 and receive suppress unit 226 to the test configurations of FIGS. 5A and 5B, we see that when TOTAL-SUPPRESSION is applied completely to one side and no suppression is added to the other, only one of the two bars 708 and 710 and similarly, one of the two points 712 and 714, changes. Specifically, as shown by FIG. 7 column 704, when the receive suppress unit 226 is set to TOTAL-SUPPRESSION and the frequency sweep generator 502 is applied as near-end speech, bar 710 and correspondingly point 714 (now shown as point 716) are reduced by TOTAL-SUPPRESSION while bar 708 and point 712 remain unchanged. Similarly, as shown by FIG. 7 column 706, when the transmit suppress unit 206 is set to TOTAL-SUPPRESSION and the frequency sweep generator 502 is applied as far-end speech, bar 708 and point 712 (now shown as point 718) are increased by TOTAL-SUPPRESSION while bar 710 and point 714 remain unchanged.

As such, based on the results of steps 406 and 408, the diagnostic algorithm next calculates TOTAL-SUPPRESSION in step 410. Specifically, TOTAL-SUPPRESSION is the overlap of bars 708 and 714 (as illustrated in FIG. 7 column 702) plus an additional “safe-margin,” for example, 9 dB (other values can be used). Accordingly, the diagnostic algorithm computes TOTAL-SUPPRESSION as (B−A)+9 dB, which using the example of above, is 18 dB.

Importantly, now that bars 708 and 710 are separated, the diagnostic algorithm can compute a MIDPOINT value (i.e., a decision threshold as shown by points 720 or 722). Specifically, the diagnostic algorithm can calculate a numerical value for MIDPOINT by either considering the receive suppress unit 226 set to TOTAL-SUPPRESSION (i.e., FIG. 7 column 704) or by considering the transmit suppress unit 206 set to TOTAL-SUPPRESSION (i.e., FIG. 7 column 706). In the current discussion, MIDPOINT is determined when considering the receive suppress unit 226 set to TOTAL-SUPPRESSION; however, again, either variation can be used. Nonetheless, which variation is used affects the functional implementation of system 200. More specifically and as further described below, because MIDPOINT is computed when considering the receive suppress unit set to TOTAL-SUPPRESSION, the transmit suppress power estimation unit 222 was added to the transmit suppress unit 216. If instead MIDPOINT is computed when considering the transmit suppress unit set to TOTAL-SUPPRESSION, the system 200 would not have the transmit suppress power estimation unit 222 but would have a similar estimation unit on the receive suppress unit 226. When considering the receive suppress unit 226 set to TOTAL-SUPPRESSION, the power at point 716 (which we can refer to as value B′) is equal to the power at point 714 (i.e., B) scaled by TOTAL-SUPPRESSION (i.e., B′=B-TOTAL-SUPPRESSION). Again, the power at point 712 (i.e., A) remains unchanged. As such, in step 412 the diagnostic algorithm computes MIDPOINT as shown in equation (4).:

MIDPOINT=[A+B′]/2 (4)

Again, for any given speakerphone utilizing my inventive system 200, the diagnostic algorithm of FIG. 4 will need to be run to determine MIDPOINT and TOTAL-SUPPRESSION.

One final note regarding the diagnostic algorithm for determining TOTAL-SUPPRESSION and MIDPOINT. The amount of TOTAL-SUPPRESSION needed to make system 200 stable is dependent on the magnitude of both the line echo and acoustic echo, as just described. However, these values are a function of the maximum speaker volume and microphone gain at the audio interface 202 as well as the worst case line impedance mismatch (including the case where other extensions are off-hook) when the line interface 204 is connected to a communications network. In other words, TOTAL-SUPPRESSION is a function of and increases as these values change. As such, when attempting to calculate TOTAL-SUPPRESSION above, these parameters should all be set to worst case values. Typically, microphone gain does not change in a speakerphone and the value to be used for the actual phone should be used when performing the above tests. The speaker volume should also be set to its maximum value. The speaker volume adjustability, which is represented by volume control unit 228 in FIG. 2, is simply another multiplier which may be greater or less than 1 and typically has a range of about 20 dB. Line echo should be tested over several types of loop conditions and the loop with the largest side-tone echo should be chosen. Note that the worse case loop condition is the one that produces the largest FES-PRE-POW when the frequency sweep generator 502 is applied to the audio interface 202 (FIG. 5B).

Before turning back to equation (3) and the determination of which side is speaking, TOTAL-SUPPRESSION should be more fully explained. As described above, the control algorithm 215 inversely varies suppression between the transmit and receive suppress units based on which side is speaking. Disregarding for the moment the affects of the acoustic and line echo cancellers, this variation in suppression is between no suppression and full suppression, which system 200 sets to TOTAL-SUPPRESSION. In addition, as described above, the control algorithm does not starkly move the transmit and receive suppress units between no suppression and TOTAL-SUPPRESSION but rather, increases suppression to one side and simultaneously decreases suppression from the other side in small steps in order to provide a more natural and smoother sounding transition. In order to keep system 200 stable, the control algorithm needs to ensure the total amount of suppression the transmit and receive suppress units are applying at any given time is equal to TOTAL-SUPPRESSION. In general, the suppression applied by each suppression unit is just a multiplier that ranges between 1 (no suppression) and TOTAL-SUPPRESSION (a value less than 1). Each 8 KHz speech sample entering system 200 from the audio or line interface is simply multiplied by the respective multiplier. Hence, if the suppression being applied at any given time by the transmit suppress unit is defined as “transmit-suppress” and the suppression being applied by the receive suppress unit at any given time is defined as “receive-suppress”, equation (5) holds true.

TOTAL-SUPPRESSION<(transmit-suppress)<1 and TOTAL-SUPPRESSION<(receive-suppress unit)<1 (5)

Accordingly, in order to keep system 200 stable, the control algorithm needs to ensure equation (6) holds true at any given time.

(transmit-suppress)*(receive-suppress)=TOTAL-SUPPRESSION (6)

or equivalently,

20log10(transmit suppress)+20log10(receive suppress)=20log10(TOTAL-SUPPRESSION) (6′)

Hence, as the control algorithm inversely varies suppression in incremental steps between the two suppress units, it needs to do so such that equation (6 or 6′) holds true. As such, the control algorithm must vary the suppression between the two suppress units in a linear fashion. In order to implement this requirement, the control algorithm uses a suppression table where the table values are a set of suppression multipliers (note that other implementations that maintain the above requirement can also be used). The size of the table is not specific to my invention, although typically the table contains 40 to 70 dB of suppression values. The table values represent a progression between 1 and TOTAL-SUPPRESSION (a value less than 1). The control algorithm maintains two indexes into this table, one for each suppress unit 216 and 226, and moves these indices through this table from opposite ends as it varies suppression between the two paths. Hence, the current position of each pointer represents the current transmit-suppress and receive-suppress values.

Importantly, to maintain the constant product of the linear transmit-suppress and receive-suppress as shown in equation (6), the table is arranged such that the index of the table represents a suppression value in dB and the table entries represent the associated linear value that is used as the suppression multiplier. The table entries are computed from the equation “value=InverseLog (index/20). For example, the index may range from 0 to 70, representing 0 to 70 dB of suppression. The value at entry 0 is 1. The value at entry 1 is 0.8912, scaled according to the appropriate Q format of the system, such as Q1.15 or Q1.31. The value at entry 70 is 0.0003162. Accordingly, as one index adds one dB of suppression, the other index removes one dB of suppression, but the total suppression in dB remains constant. Of course, the table index need not start at 0 dB and can be scaled to any value, for instance, to always maintain a minimum amount of suppression in the system. This table approach eliminates the need for an inverse logarithm function within the program as the inverse log values are pre-computed for a set of suppression values between 0 dB and TOTAL SUPPRESSION. The linear suppression values read from the table for each of the transmit and receive suppress units are multiplied against the transmit or receive signal respectively to implement digital suppression. But, in all cases, the total suppression product remains constant.

One final comment on TOTAL-SUPPRESSION. While the control algorithm inversely varies the two suppress units between the two extremes of no suppression and TOTAL-SUPPRESSION, the control algorithm also monitors the performance of the two echo cancellers and takes this performance into consideration when varying the suppress units. As a result, the control algorithm's objective is to never actually move a suppress unit completely to TOTAL-SUPPRESSION, thereby achieving full-duplex operation. Hence, while TOTAL-SUPPRESSION is needed to keep system 200 stable, this stability is actually achieved through the combination of the suppress units and echo cancellers.

Turning now back to equation (3) and the determination of which side is speaking, as shown by FIG. 7 columns 704 and 706, MIDPOINT will linearly move between two extremes (point 720 and 722) as the control algorithm linearly varies the receive suppress unit 226 and transmit suppress unit 206 between no suppression and TOTAL-SUPPRESSION. In other words, because the control algorithm varies the suppression in a linear fashion, the distance between the bars 708 and 710 will remain constant. As such, as suppression is removed from the receive side and applied to the transmit side (i.e., as a transition is made between columns 704 and 706) and vise versa, MIDPOINT will move up with the bars and this movement will be linear because the distance between bars 708 and 710 will not change. However, this movement of the MIDPOINT must be accounted for in the speech detection equation (3). Because the diagnostic algorithm computed MIDPOINT using TOTAL-SUPPRESSION applied to the receive suppress unit 226 and set the transmit suppress unit 206 to no suppression (as shown in equation (4)), the change in MIDPOINT can be accounted for by scaling it by the amount of suppression the transmit suppress unit 206 is applying at any given time. As such, in accordance with my invention, the control algorithm determines which side is speaking as shown in equation (7).

| | |
|---|---|
| If (NES-PRE-POW * (suppression applied by transmit suppress | (7) |

unit)) > (FES-PRE-POW * MIDPOINT)

→ the near-end is speaking

else

→ the far-end is speaking

Importantly, the recursion used for the speech power estimates as shown by equation (1) has a transient response associated with it. That is, if a gain (or in my case, a suppression) is applied to a constant power signal such as a steady tone, the power estimate will not reach a steady state until a certain amount of time passes. Since the control algorithm uses the transmit suppression to scale MIDPOINT, the right side of equation (7) (i.e., (FES-PRE-POW*MIDPOINT)) will adjust faster than the left side (i.e., NES-PRE-POW*(suppression applied by transmit suppress unit)). If this transient response is not accounted for in equation (7), decision errors could occur during rapid transitions of speech direction. A such and in accordance with a further embodiment of my invention, SUPP-POW 222 is used to resolve this issue. SUPP-POW obtains a power estimate of the transmit suppression unit 216. This power estimate can be substituted for the actual value of the transmit suppression unit in equation (7). It represents an average of the suppression used during the window time constant rather the instantaneous suppression, which can be significantly different from the time-averaged value. The resulting alternate method for determining which side is speaking in shown in equation (8).

| | |
|---|---|
| If (NES-PRE-POW * SUPP-POW) > | (8) |
| (FES-PRE-POW * MIDPOINT) | |

→ the near-end is speaking.

else

→ the far-end is speaking.

A further note regarding the speech detection algorithm of equations (7) and (8). As just described, the control algorithm uses the acoustic echo canceller 210 and line echo canceller 212 to prevent the transmit and receive suppress units from ever reaching TOTAL-SUPPRESSION. However, in computing MIDPOINT, the diagnostic algorithm assumed the suppress units reached TOTAL-SUPPRESSION. As a result, the control algorithm needs to take the effect of the echo cancellers into account when computing equations (7) and (8). More specifically, the acoustic echo canceller 210 helps to decrease the amount of suppression the transmit suppress unit 216 needs to apply to the transmit side. As just described, the transmit suppress unit, either through the actual suppression applied (i.e., equation (7)) or through SUPP-POW 222 (i.e., equation (8)), is already used to scale MIDPOINT and as such, the affect of the acoustic canceller is accounted for in equations (7) and (8). Similarly, the line echo canceller 212 helps to reduce the amount of suppression the receive suppression unit 226 needs to apply to the receive side. When MIDPOINT was determined, full suppression on the receive side was assumed. However, the affect of the line echo canceller is not currently accounted for in equations (7) and (8). As such, MIDPOINT in equations (7) and (8) must be scaled as a result of the echo removed by the line echo canceller. As such, as the control algorithm continuously monitors the line echo canceller to determine the amount of echo it is removing and uses this determined value to move the receive suppress unit away from TOTAL-SUPPRESSION, it also notes this varying value, which can be referred to as LEC-ADJ, for the purposes of scaling the speech detection algorithm. As a result, the final speech detection algorithm is shown in equations (7′) and (8′).

| | |
|---|---|
| If (NES-PRE-POW*(“transmit suppress”)) > | (7′) |
| FES-PRE-POW*MIDPOINT*LEC-ADJ) | |

→ the near-end is speaking.

else

→ the far-end is speaking.

| | |
|---|---|
| If (NES-PRE-POW * SUPP-POW) > | (8′) |
| (FES-PRE-POW * MIDPOINT * LEC-ADJ) | |

→ the near-end is speaking.

else

→ the far-end is speaking

One final note regarding the speech detection algorithm of equations (7′) and (8′). As discussed above, the volume control unit 228 is set to a worst-case level when determining TOTAL-SUPPRESSION. As a result, TOTAL-SUPPRESSION will be larger than perhaps necessary because users may not set the volume control unit to this level. As such, the system 200 may tend to suppress speech to levels that are uncomfortable or choppy-sounding during operation. This is particularly an issue if the volume control unit 228 is set to low volumes. As such, in accordance with a further embodiment of my invention, the control algorithm can also monitor the level of the volume control unit 228 during operation. Specifically, when the volume control unit 228 is set at a maximum value, bars 708 and point 712/718 move down in FIG. 7 columns 702, 704, and 706 (again, the reason why TOTAL-SUPPRESSION needs to be increased). However, as volume control unit 228 is set to lesser values during operation, bar 708 and point 712/718 move up in all three columns. As result, TOTAL-SUPPRESSION can be set to a lesser value. As result, by monitoring the volume control unit 228 during operation, the control algorithm can constantly adjust TOTAL-SUPPRESSION needed to keep the system stable. As a result, MIDPOINT must also be adjusted in equations (7′) and (8′) since it is a function of TOTAL-SUPPRESSION.

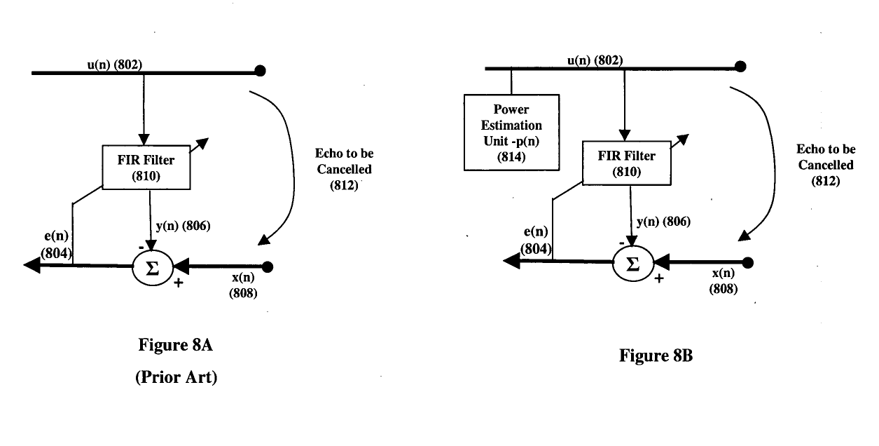

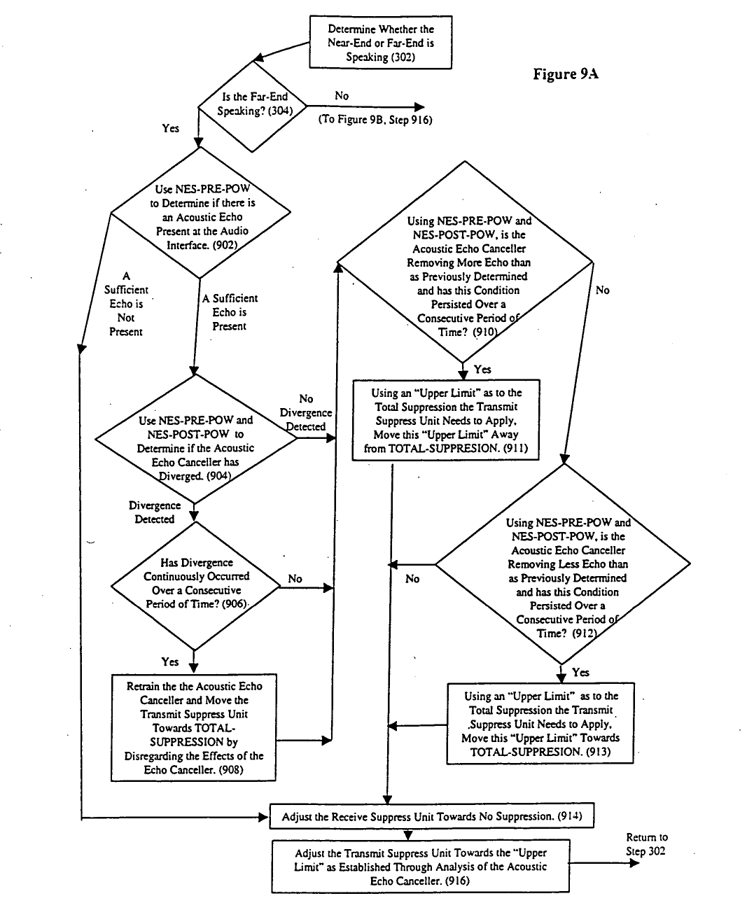

Turning now to the acoustic and line echo cancellers 210 and 212, as indicated, both are adaptive linear filters. Specifically, each filter is a standard N tap Finite Impulse Response (FIR) transversal filter whose coefficients are computed using a least mean squared (LMS) algorithm. FIG. 8A shows an illustrative example of each filter. As indicated, in accordance with my invention, each filter 210 and 212 is continuously operated in one of two modes, training mode and operational mode, training mode being conducted when the control algorithm detects the echo canceller to have diverged. Referring to FIG. 8A, the signal u(n) 802 is referred to as the reference signal (this signal is equivalent to the transmit and receive signals present on the transmit path 206 and receive path 208). This signal is output to the echo interface 812 yielding the actual echo signal x(n) 808. The reference signal u(n) is also processed through the echo canceller's FIR filter 810 to produce the estimated echo y(n) 806 of the actual echo x(n). The error e(n) 804 is the difference between the estimated and actual echoes and is used to update the filter coefficients during training mode. The error e(n) also represents the “result” of the echo canceller 810 after the estimated echo y(n) is removed from the actual echo in operational mode. During training mode, u(n) 802 and e(n) 806 are processed and the filter coefficients are updated to give the best estimation y(n) 806 of the actual echo x(n) 808 in a least mean squared sense. During operational mode, the signal u(n) is still processed but the filter coefficients are not updated and remain constant.

The operation of each filter 210 and 212 is represented as shown in equations (9) and (10).

y(n)=ρᵢ^{N}W(i)u(n−1) (9)

e(n)=x(n)−y(n) (10)

where W(i) represents each of the N filter coefficients. During training mode, the filter coefficients, W, are updated every audio sample using the LMS recursion. The updating of the filter coefficients is represented as shown in equation (11).

\overline{W(n+1)}=\overline{W(n)}+μe(n)\overline{u(n)} (11)

where the bars over W(n+1) and W(n) indicate that these are vectors containing the N filter coefficients, the bar over u(n) indicates this a vector of N samples (u(n), u(n−1), . . . , u(n−N−1)), and μ is an adaptation step size parameter.

The rate at which the filter coefficients W adapt to stable values that provide a reasonable echo attenuation is known as convergence rate. In general, it is desirable to keep the convergence rate fast. The filter length, the power level of the reference signal u(n), and the step size parameter μ primarily affect the convergence rate. In general, note that as the step size parameter μ increases the filter converges faster but the residual echo (which results from a non-perfect approximation of the echo) also increases. As a result, a smaller step size results in a better set of coefficients. In accordance with my invention, there is a fixed step size chosen empirically that provides convergence with an acceptable convergence rate based on an expected set of operating conditions. As for the filter lengths, the acoustic echo canceller 210 filter length is set to 512, and the line echo canceller 212 filter length is set to 128, although other values can be used.

With respect to the power level of the reference signal u(n), as it increases the filters 210 and 212 converge at a faster rate. In general, it is desirable to have an echo canceller with a convergence rate that stays relatively constant over different levels of speech. As indicated, we continuously train the echo cancellers during operation of the speakerphone as the user speaks. As such and in accordance with a further embodiment of my invention, the step size μ is normalized by the power of the reference signal u(n) to ensure the convergence rate stays relatively constant over varying speech levels. The power of the reference signal u(n) is taken by a power estimation unit 814 as shown in FIG. 8B. The resulting algorithm for updating the filter coefficients, known as Normalized Least Mean Squared or NLMS, is shown in equation (12).

$$\overline{W ( n + 1 )} = \overline{W ( n )} + \frac{μ}{p ( n )} e ( n ) \overline{u ( n )} \qquad ( 12 )$$

where p(n) represents the power estimation taken by unit 814. When updating the acoustic echo canceller 210, p(n) represents a power estimate taken by NES-PRE-POW 218 and when updating the line echo canceller 212, p(n) represents a power estimate taken by FES-PRE-POW 232.

One final note regarding the LMS algorithm used to adapt the filter coefficients of the echo cancellers 210 and 212. In accordance with a further embodiment of my invention, a variation of LMS, known as block adaptive LMS, can be used. In standard LMS, all N filter coefficients are updated on every sample as shown above in equations (11) and (12). However, the N coefficients, W(0)-W(N−1), can be separated into M blocks of size L samples (where M*L must equal N), as shown in equation (13), where only one block is updated per sample.

Block 0: w(0), w(M), w(2M), . . . w(N−M) (13)

Block 1: w(1), w(M+1), w(2M+1), . . . w(N−M+1)

Block 2: w(2), w(M+2), w(2M+2), . . . w(N−M+2)

+

+

+

Block M−1: w(M−1), w(2M−1), w(3M−1), . . . w(N−1)

Here, the NLMS algorithm for updating the filter coefficients is represented by equation (14).

$$h = ( h + 1 ) ModuloM \\ {W}_{k} ( n + 1 ) = {W}_{k} ( n ) + \frac{μ}{p ( n )} {\sum }_{m = 0}^{M - 1} e ( n - m ) u ( n - k - m ) \qquad ( 14 )$$

where k=h, h+M, h+2M, etc. (with h initialized to 0) and where Wₖ(n) is the k^{th} coefficient of W at sample n. Note that there are no bars over W(n) and u(n) since these are scalars rather than vectors. For any given sample, only one of the M blocks of L coefficients is updated. Study and experimentation reveal that the block update LMS algorithm for adaptive filters performs better than the standard LMS when speech is used as a reference signal. In addition, the block update LMS equation can be implemented using fewer operations (add or multiply) than that of the standard LMS equation for the same size filter. In accordance with this embodiment of my invention, the acoustic echo canceller has M set to 32 and L is set to 16 providing a tail length of 64 milliseconds (32*16=N=512) and the line echo canceller has M set to 8 and L set to 16 providing a tail length of 16 milliseconds (8*16=N=128), although other values again can be used. Note that longer tail lengths can be achieved by increasing the filter lengths.

Note that with respect to retraining the filter coefficients, it is important that the control algorithm only trains the acoustic echo canceller when far-end speech is present and only trains the line echo canceller when near-end speech is present. During this time, the coefficients of the other echo canceller should be frozen. For example, in the case of a line interface echo 238 and line echo canceller 212, the signal u(n) represents near-end speech and x(n) represents the side tone, which is essentially the reference signal u(n) processed through some system. In this example, when far-end speech occurs it will be additive with the near-end speech side tone x(n) and will appear in signal e(n) to the line echo canceller. In other words, because the far-end speech is not present in the reference signal u(n), it will not be subtracted out from x(n). Therefore, e(n) will contain the attenuated echo plus the far-end speech. This situation is desirable when operating the line echo canceller in operational mode where the coefficients have been frozen. However, when operating the line echo canceller in training mode the LMS algorithm will attempt to minimize the error signal e(n), which is impossible since it has no reference. As a result, the filter coefficients will diverge from appropriate values. This can cause the line echo canceller to not only be incapable of canceling the echo, but to actually increase the echo and in some situations can cause the entire system to become instable and exhibit howling (the same holds true for the acoustic echo canceller 210). Again, the control algorithm uses the speech detection equation (7′) and (8′) to determine which end is speaking and trains the corresponding echo canceller.

It is also important to note why system 200 continuously retrains the echo cancellers. As specified, the control algorithm 215 continuously monitors the operation of the echo cancellers during operation of the speakerphone to detect divergence and when divergence is detected, retrains the echo cancellers to adapt the filter coefficients to the current environment. This method is contrary to prior are systems that have a user periodically place the system in training mode, train the filter coefficients to that user's voice or to a predetermined signal, and then freeze the coefficients during operation. My method is advantageous over the prior are for several reasons. First, because the acoustic and line echoes are modeled as linear systems, we can assume that the frequency response of the actual echoes represents a magnitude and phase shift at every frequency comprising the reference signal (i.e., voice) u(n). As such, during training mode, each echo canceller will only adapt to represent the response of those frequencies that are actually present in the reference signal. However, the reference signal (i.e., voice) used to train the system may not be the same signal (i.e., voice) used during operation of the system. As a result, each filter should technically be trained using a white noise reference signal whose power is constant at all frequencies in order to obtain the best representation of the echoes for any possible user. It is well know however that speech is not a white noise signal but rather, contains large amounts of energy in certain spectral areas and little or no energy at other frequencies. This represents a problem in prior art systems when speech is used as the reference signal to train the filters during initial operation and the coefficients are then frozen because if the reference signal is not white noise but instead contains spectral areas where no, or very little energy is present, the filter coefficients W will not give a good approximation of the echo at those frequencies where no speech energy is present. Hence, the systems are not trained for any subsequent user. As such, the echo filters in these prior art systems need to be trained for an indeterminate amount of time during initial operation to ensure all frequencies have been accounted for. My method of continuously monitoring and retraining the echo cancellers during operation overcomes this issue because the filter coefficients are always representative of the current reference signal's frequency content and as a result, the echo filters of my invention obtain a better approximation of the current echo.

Note that prior systems that use a predetermined signal to train on during setup overcome the issues associated with the systems that use voice signals to train on during setup. However, even here my method of continuously and automatically training the echo cancellers on voice has the advantage that the user does not need to perform this additional installation procedure.

A second advantage of continuously retraining the echo cancellers of my invention (as compared to training the echo cancellers during setup to a voice or predetermined signal) is that the response of the line echo 238 and acoustic echo 236 may change over time. Specifically, from one call to another the communications network/telephone network interface impedance may change (as is often the case when Private Branch Exchanges are employed), which will cause the line echo to change with each new call. In addition, when other phone extensions on the same line are taken off-hook during a call, the line impedance will change causing the line echo to change as well. Similarly, the acoustic echo may change as the speakerphone environment varies. In particular, acoustic echoes are affected not only by the size and shape of the room and the particular speakerphone's plastic casing, but also by other objects that create sound wave reflections such as doors, people, etc. Again, these variances in the line echo and acoustic echo can be accounted for by continuously retraining the filters.

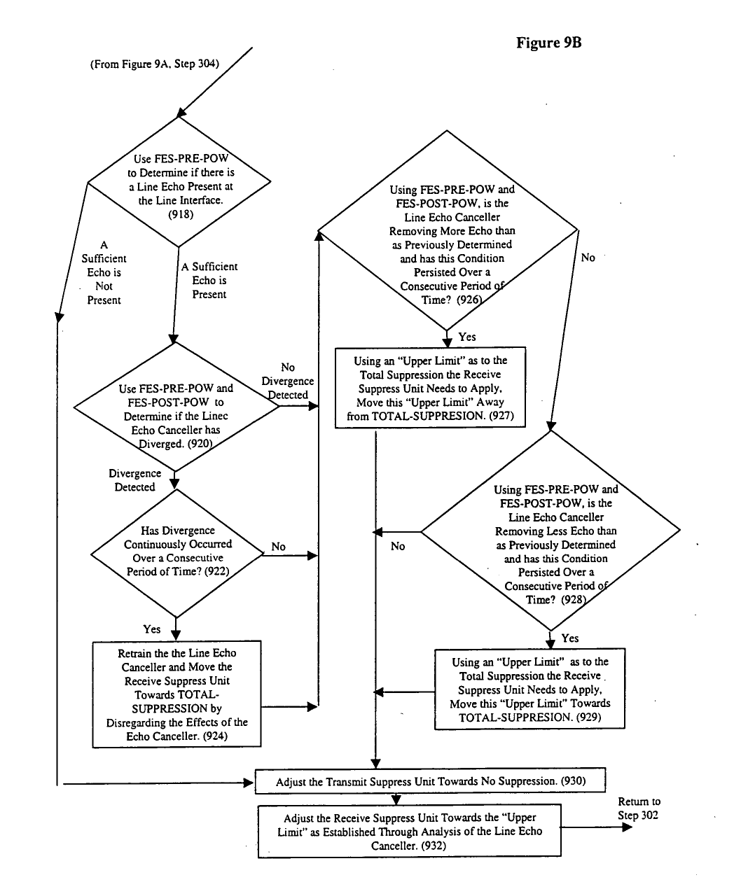

Reference will now made in greater detail to the remaining steps of control algorithm 215 as shown in FIG. 3. Steps 302 and 304, the determination as to whether near-end or far-end speech is present, was described above and is represented by equation (7′) or (8′). As indicated, when the system determines that the far-end is speaking, it proceeds to step 306-312, where the accoutsic echo canceller is retrained (if necessary), the receive suppress unit is moved towards no suppression, and the transmit suppress unit is moved towards total suppression, taking into account the performance of the acoustic echo canceller. Similarly, when the system determines that the near-end is speaking, it proceeds to step 314-320, where the line echo canceller is retrained (if necessary), the transmit suppress unit is moved towards no suppression, and the receive suppress unit is moved towards total suppression, taking into account the performance of the line echo canceller. FIGS. 9A and 9B further detail steps 306-320, beginning with the determination that the far-end is speaking.

As indicated, once the control algorithm determines the far-end is speaking, it first determines if the acoustic echo canceller has diverged. However, prior to performing this step and as shown by step 902, the control algorithm first monitors NES-PRE-POW 218 to determine if there is detectable levels of speech (i.e., echo) present on the transmit interface. Specifically, when neither far-end or near-end speech is present, system 200 continues to experience ambient noise and the control algorithm will still make a determination based on these levels as to whether the far-end or the near-end speaking. However, if only ambient noise is present in the system, the acoustic echo canceller does not have a representative reference signal u(n) 802 or echo signal x(n) 808 on which to train. In addition, due to the ambient noise, there is no representative signal on which to determine the performance of the echo canceller. As such, the control algorithm should not make any determination with respect to the echo canceller's performance. Accordingly, in step 902 the control algorithm first examines NES-PRE-POW 218 to determine the speech energy at point 240 and then compares NES-PRE-POW to a threshold value that represents the power level of the ambient noise during silence at the audio interface 202. This threshold value is hardware specific and can be experimentally determined and therefore statically set. Alternatively, the control algorithm can dynamically determine the threshold value by observing the long-term power estimate of the ambient noise during silence and adjusting the threshold accordingly. Such a method would allow for better performance over a wide range of operating conditions (noisy rooms, etc.).

If the control algorithm determines that there is not sufficient speech energy beyond ambient noise present at the audio interface and thereby no acoustic echo, it moves to step 914, where it maintains it current view of the acoustic echo canceller's performance and proceeds to move the receive suppress unit towards no suppression and the transmit suppress unit towards TOTAL-SUPPRESSION. Step 914 is further described below.

If however, the control algorithm determines that there is speech energy beyond ambient noise present at the audio interface, it moves to step 904 to determine if the acoustic echo canceller has diverged. The control algorithm makes this determination by comparing NES-PRE-POW 218 to NES-POST-POW 220. Specifically, the echo canceller's output power (NES-POST-POW) should never exceed its input power (NES-PRE-POW). As shown be equation (15), if NES-POST-POW exceeds NES-PRE-POW by a threshold value (here referred to as THRESH1), the control algorithm determines that the acoustic echo canceller has diverged. Note that THRESH1 is again an experimentally determined value that is system specific (in general, note that THRESH1 should be longer than the convergence time of the echo canceller determined by the selection of the step size).

| | |
|---|---|
| If ((NES-POST-POW > (NES-PRE-POW + THRESH1)) | (15) |

→ the Acoustic Echo Canceller has Diverged

However, rather than immediately retrain the echo canceller, the control algorithm first ensures that the divergence condition lasts for a given period of consecutive voice samples (e.g., 400-500 msec.) (step 906) to ensure the echo canceller has actually diverged (e.g., this can be done by maintaining internal counters). Assuming the control algorithm detects divergence over the given period, it moves to step 908 and resets the acoustic echo canceller using methods described above. As part of the reset, the control algorithm moves the transmit suppress unit 216 towards TOTAL-SUPPRESSION by essentially disregarding the effects of the acoustic echo canceller (as further described below, this entails moving a suppression table pointer, referred to as minimum-suppression-index, back to TOTAL-SUPPRESSION).

Once examining and possibly resetting the acoustic echo canceller, the control algorithm next proceeds to step 910 and examines the performance of the echo canceller to determine if it is removing sufficient echo such that the transmit suppress unit 216 does not need to be set at TOTAL-SUPPRESSION. Before describing step 910 in detail, we should first overview one method on how system 200 can track suppression although, this method is not specific to my invention and other methods can be used. As discussed above, in order to control the amount of suppression the transmit and receive suppress units 216 and 226 are applying, the control algorithm maintains a suppression table where the table values are suppression multipliers. The control algorithm maintains two indexes into this table, one for each suppress unit 216 and 226, and moves these indexes through this table from opposite ends and in a step wise fashion over the voice samples it receives as it linearly varies suppression between the two paths. Accordingly, the control algorithm will determine which end is speaking and based on this determination, move each index towards opposite ends of the table. As an example, assuming the control algorithm consistenly determines the same side is speaking, one suppress unit will migrate towards no suppression and the other unit will migtrate towards TOTAL-SUPPRESSION.

However, as indicated, the control algorithm also takes into account the amount of echo a given echo canceller is removing to prevent a suppress unit from totally migrating towards TOTAL-SUPPRESSION. Hence, the control algorithm also maintains a third pointer (which we can refer to as the “minimum-suppression-index”) into the suppression table. Based on the amount of echo the control algorithm determines an echo canceller is removing, the control algorithm sets the minimum-suppression-index as the outer limit of the suppression table (i.e., to some value in the table that is less than TOTAL-SUPPRESSION). As such, rather than migrating a suppress unit's pointer towards TOTAL-SUPPRESSION, the control algorithm will migrate it towards the minimum-suppression-index and make it track this pointer. Accordingly, as indicated above, system 200 must maintain TOTAL-SUPPRESSION to achieve stability; however, TOTAL-SUPPRESSION is achieved through a combination of the two suppress units and the echo cancellers. Nonetheless, note that there is a limit as to the maximum amount of suppression the control algorithm will allow the echo cancellers to contribute towards TOTAL-SUPPRESSION, a value we refer to as MAX-SUP-REMOVABLE.

More specifically, system 200 requires TOTAL-SUPPRESSION to maintain stability. As indicated, this suppression can come from the suppress units, the echo cancellers, or a combination of both. At startup, all the suppression is coming from the suppress units. However, as the echo cancellers train, less multiplier suppression is needed from these units. Assume that at any given time, the amount of combined suppression provided by the suppress units after the echo cancellers are providing suppression is X dB. In this case, X dB is the maximum dB the echo cancellers can continue to remove from the system. MAX-SUP-REMOVABLE is simply a limit on this value X, or in other words, the lowest level the control algorithm will allow the suppress units to move to. Conversely, MAX-SUP-REMOVABLE can be viewed as the maximum amount of suppression towards TOTAL-SUPPRESSION that the control algorithm will allow the echo cancellers to compensate for. Ideally, MAX-SUP-REMOVABLE could be set such that the control algorithm would allow the echo cancellers to fully compensate for TOTAL-SUPPRESSION and the suppress units provide no suppression. However, we set MAX-SUP-REMOVABLE so that typically, 6 to 12 dB of suppression is always left within the suppress units to provide a safety cushion in the system to prevent howling during transient responses of the echo cancellers. Nonetheless, if the echo cancellers are performing well, they compensate for up to MAX-SUP-REMOVABLE of TOTAL-SUPPRESSION.

Again, note that while a suppression table and the use of the indices as described above is one method for implementing my invention, this method is not specific to the invention. What is significant here is the determination of TOTAL-SUPPRESSION, the linear and incremental tracking of the suppression units with respect to this value, and the constant monitoring of the echo cancellers' performance such that the suppress units need not apply TOTAL-SUPPRESSION.

Returning to step 910, the control algorithm determines the performance of the acoustic echo canceller by comparing NES-PRE-POW and NES-POST-POW. Specifically, assume the control algorithm has previously compared NES-PRE-POW and NES-POST-POW and determined the acoustic echo canceller is removing XdB (note that the control algorithm begins under the assumption that the echo canceller is removing 0 dB). The control algorithm now needs to determine if the echo canceller is continuing to remove XdB, is removing more than XdB, or is now removing less than XdB of echo. Based on this determination, the control algorithm adjusts the minimum-suppression-index, as described above, relative to TOTAL-SUPPRESSION, which in turn affects the amount of suppression the transmit suppress unit applies.

In particular, in step 910, the control algorithm compares NES-PRE-POW and NES-POST-POW with respect to (X+1)dB as shown in equation (16) to determine if the acoustic echo canceller is removing more echo than previously determined (note that step sizes other than 1 dB can be used). If so, the control algorithm proceeds to step 911 and increments the minimum-suppression-index from its current position by one step away from TOTAL-SUPPRESSION (note that the amount of the incremental movement made to minimum-suppression-index is not specific to my invention and increments other than one can be used). However, similar to above with respect to resetting the acoustic echo canceller, the minimum-suppression-index is preferably not incremented unless the condition set forth in equation (16) holds constant for a given period of consecutive voice samples (e.g., 50 msec giving a suppression slew rate of 20 dB/second) in order to ensure the consistent performance of the echo canceller. It should also be noted that the minimum-suppression-index is moved as long as the echo canceller is removing less than MAX-SUP-REMOVABLE dB. Once the control algorithm determines NES-PRE-POW and NES-POST-POW differ by more than MAX_SUP_REMOVABLE dB, the minimum-suppression-index is no longer moved.

| | |
|---|---|
| If ((NES-POST-POW * (X+1)dB) < NES-PRE-POW) | (16) |

→ increment minimum-suppression-index

If, however, equation (16) does not hold true, the control algorithm proceeds from step 910 to step 912 and compares NES-PRE-POW and NES-POST-POW with respect to (X)db as shown in equation (17) to determine if the acoustic echo canceller is removing less echo than as previously determined. If so, the control algorithm proceeds to step 913 and decrements the minimum-suppression-index from its current position one step towards TOTAL-SUPPRESSION (again, incremental steps other than one can be used). Again, the minimum-suppression-index is preferably not decremented unless the condition set forth in equation (17) holds constant for a given period of consecutive voice samples (e.g., half the value used when equation (16) holds true, or in other words, 25 msec since it is preferable to add suppression faster to prevent instability) in order to ensure the consistent performance of the echo canceller.

| | |
|---|---|
| If ((NES-POST-POW * (X)dB) > NES-PRE-POW) | (17) |

→ decremented minimum-suppression-index

Once determining the performance of the acoustic echo canceller, the control algorithm moves to step 914 and adjusts the transmit suppress unit 216 and receive suppress unit 226. In particular, the control algorithm moves the suppression table index corresponding to the recieve suppress unit one step towards no suppression, given that the far-end is speaking, and then applies this suppression to the unit. It then proceeds to step 916 where it compares the suppression table index corresponding to the transmit suppress unit to the minimum-suppression-index. Again, the intent is to move the transmit suppress unit's index one step towards TOTAL-SUPPRESSION, but using the minimum-suppression-index as the upper limit, thereby taking into account the echo removed by the acoustic echo canceller. Note, that because the control algorithm continuously tracks and adjusts the system based on the performance of the acoustic echo canceller, the transmit suppress unit's index may be greater than or less than the minimum-suppression-index. What is important is the control algorithm track minimum-suppression-index and move the transmit suppress unit's index towards it. Once updating the index, the control unit applies the new suppression to the transmit suppress unit.

Turning now to when the control algorithm determines the near-end is speaking, the control algorithm proceeds similarly as described above with respect to steps 902-916 and begins by determining if the line echo canceller has diverged. In particular, beginning with step 918, the control algorithm first monitors FES-PRE-POW 232 to determine if there is detectable levels of speech present on the receive interface and not simply ambient noise, which would mean the line echo canceller does not have a representative reference signal u(n) 802 or echo signal x(n) 808 on which to train and no representative signal on which to determine the performance of the echo canceller. As such, the control algorithm should not make any determination with respect to the echo canceller's performance. Accordingly, the control algorithm first examines FES-PRE-POW 232 in step 918 to determine the speech energy at point 246 and then compares FES-PRE-POW to a threshold value that represents the power level of the ambient noise during silence at the line interface 204. Again, this threshold value can be experimentally determined or can be dynamically determined by observing the long-term power estimate of the ambient noise during silence and adjusting the threshold accordingly.

If the control algorithm determines that there is not sufficient speech energy beyond ambient noise present at the line interface and thereby no line echo, it moves to step 932, where it maintains it current view of the line echo canceller's performance and proceeds to move the transmit suppress unit towards no suppression and the receive suppress unit towards TOTAL-SUPPRESSION. Step 932 is further described below.

If however, the control algorithm determines that there is speech energy beyond ambient noise present at the line interface, it moves to step 920 to determine if the line echo canceller has diverged. As shown in equation (18), the control algorithm makes this determination by comparing FES-PRE-POW 232 to FES-POST-POW 230 to determine if FES-POST-POW exceeds FES-PRE-POW by a given threshold value (here referred to as THRESH2), which again is system specific and can be experimentally determined (in general, note that THRESH2 should be longer than the convergence time of the echo canceller determined by the selection of the step size).

| | |
|---|---|
| If ((FES-POST-POW > (PES-PRE-POW + THRESH2)) | (18) |

→ the Line Echo Canceller has Diverged

If the control algorithm determines the line echo canceller has diverged, it proceeds to step 922 where it ensures that the divergence condition lasts for a given period of consecutive voice samples (e.g., 400-500 msec.) to ensure the echo canceller has actually diverged. Assuming the control algorithm detects divergence over the given period, it moves to step 924 and retrains the line echo canceller. As part of the retraining, the control algorithm moves the receive suppress unit 216 towards TOTAL-SUPPRESSION by essentially disregarding the effects of the line echo canceller (as described above, this entails moving/resetting minimum-suppression-index back to TOTAL-SUPPRESSION).

Once examining and possibly retraining the line echo canceller, the control algorithm next proceeds to step 926 and examines the performance of the echo canceller to determine if it is removing sufficient echo such that the received suppress unit does not need to be set at TOTAL-SUPPRESSION. Again, the control algorithm will proceed similarly to steps 910 and 912 for the acoustic echo canceller. In particular, assuming the control algorithm has previously determined that the line echo canceller is removing XdB, the control algorithm in step 926 compares FES-PRE-POW and FES-POST-POW with respect to (X+1)dB as shown in equation (19) to determine if the line echo canceller is removing more echo than as previously determined (again, step sizes other than 1 dB can be used). If so, the control algorithm proceeds to step 927 and increments minimum-suppression-index from its current position by one step away from TOTAL_SUPPRESSION (incremental steps other than one can be used), again, only doing so if the condition set forth in equation (19) holds constant for given period of consecutive voice samples (e.g., 25 msec.; note that this slew rate is typically faster than that used for the acoustic echo canceller counter-part described above because the line echo canceller echo path delay is significantly less.) in order to ensure the consistent performance of the line echo canceller. Note also that similar to step 912, the control algorithm will not increment the minimum-suppression-index once it determines the line echo canceller is removing MAX-SUP-REMOVABLE dB.

| | |
|---|---|
| If ((FES-POST-POW * (X+1)dB) < FES-PRE-POW) | (19) |

→ increment minimum-suppression-index.

It should be further noted, that as discussed above with respect to equations (7′) and (8′), the equations by which the control algorithm determines which side is speaking, the equations included the scaling factor “LEC-ADJ”, which accounted for the echo removed by the line echo canceller. As can now be more fully explained, the control algorithm adjusts “LEC-ADJ” during step 926 based on the adjustments it makes to the minimum-suppression-index.

Turning now to step 928, if equation (19) does not hold true, the control algorithm compares FES-PRE-POW and FES-POST-POW with respect to (X)db as shown in equation (20) to determine if the line echo canceller is removing less echo than as previsouly determined. If so, the control algorithm proceeds to step 929 and decrements minimum-suppression-index from its current position one step towards TOTAL-SUPPRESSION, again, only doing so if the condition set forth in equation (20) holds constant for given period of consecutive voice samples (e.g., half the value used when equation (19) holds true, or in other words, 12.5 msec since it is preferable to add suppression faster to prevent instability).

| | |
|---|---|
| If ((FES-POST-POW * (X)dB) > FES-PRE-POW) | (20) |

→ decrement minimum-suppression-index.

Once determining the performance of the line echo canceller, the control algorithm next moves to step 930 and adjusts the transmit suppress unit and receive suppress unit. In particular, the control algorithm moves the suppression table index corresponding to the tranmsit suppress unit one step towards no suppression, given that the near-end is speaking, and then applies this suppression to the unit. It then proceeds to step 932 where it compares the suppression table index corresponding to the receive suppress unit to minimum-suppression-index, moving the receive suppress unit's index one step towards minimum-suppression-index. Again, the intent is to move the receive suppress unit's index one step towards TOTAL-SUPPRESSION, but using the minimum-suppression-index as the upper limit, thereby taking into account the echo removed by the line echo canceller. Once updating the index, the control unit applies the new suppression to the receive suppress unit.

The above-described embodiments of my invention are intended to be illustrative only. Numerous other embodiments may be devised by those skilled in the art without departing from the spirit and scope of my invention.

I claim:

1. A method for providing full-duplex speakerphone operation wherein the speakerphone comprises an audio interface, a line interface, a transmit path from the audio interface to the line interface, a receive path from the line interface to the audio interface, an acoustic echo canceller across the audio interface, a line echo canceller across the line interface, a transmit suppress unit in the transmit path, and a receive suppress unit in the receive path, said method comprising the steps of:
during manufacturing:
using frequency sweeps to determine a total suppression that the combination of the acoustic echo canceller, the line echo canceller, the transmit suppress unit, and the receive suppress unit must continuously supply in order to keep the speakerphone stable, and
determining a midpoint relative to the total suppression, during operation:
determining a power estimation of near-end speech from the audio interface and a power estimation of far-end speech from the line interface,
comparing the near-end and far-end power estimations to the midpoint to determine whether the near-end or far-end is speaking,
if the far-end is speaking,
determining whether the acoustic echo canceller has diverged and is so, resetting the acoustic echo canceller,
determining the performance of the acoustic echo canceller,
adjusting the transit suppress unit away from total suppression based on the acoustic echo canceller performance, and
adjusting the receive suppress unit towards no suppression, and if the near-end is speaking,
determining whether the line echo canceller has diverged and if so, resetting the line echo canceller,
determining the performance of the line echo canceller,
adjusting the receive suppress unit away from total suppression based on the line echo canceller performance, and
adjusting the transmit suppress unit towards no suppression.
